(19) United States
(12) Patent Application Publication
(10) Pub. No.: US 2024/0025219 A1
(43) Pub. Date: Jan. 25, 2024

(54) SYSTEM, METHOD AND APPARATUS FOR SUPPORT STRUCTURE

(71) Applicant: DOCK N STOW LLC, Highlands Ranch, CO (US)

(72) Inventors: Mark Gregory, Highlands Ranch, CO (US); Sean Cummins, Bellevue, WA (US); Philip Powers, Lafayette, CO (US)

(73) Assignee: DOCK N STOW LLC, Highlands Ranch, CO (US)

(21) Appl. No.: 18/222,307

(22) Filed: Jul. 14, 2023

Related U.S. Application Data
(60) Provisional application No. 63/390,362, filed on Jul. 19, 2022.

(51) Int. Cl. B60D 1/66

(52) U.S. Cl. CPC B60D 1/66

(57) ABSTRACT

A support structure has a base with a top and recesses. Inserts are mounted in respective ones of the recesses. Each insert has a protrusion that extends from the insert. The inserts are reversible and invertible. The inserts include: a first configuration where the protrusions extend above the top of the base and are located in a first position; a second configuration where the protrusions extend above the top of the base and are located in a second position that differs from the first position; and a third configuration where the protrusions extend into the recesses below the top of the base such that the inserts are flush with the top of the base.

### CROSS-REFERENCE TO RELATED APPLICATION

This application claims priority to and the benefit of U.S. Prov. Pat. App. No. 63/390,362, filed Jul. 19, 2022, which is incorporated herein by reference in its entirety.

### BACKGROUND

### Field of the Disclosure

The present disclosure relates in general to support structures and, in particular, a system, method and apparatus for a support structure for trailers that are towed behind a motor vehicle.

### Description of the Prior Art

Conventional trailers, such as hauling trailers that are towed behind a motor vehicle, have jack wheel posts and attached jack wheels or plate jack stands. Such posts or stands typically are supported on an underlying surface (e.g., the ground) in insufficient ways when the trailers are uncoupled from the vehicle used to tow them. For example, some trailer owners simply allow the jack post, the jack wheel, or the flat foot or plate jack stand that is attached to the post, to merely rest upon the bare ground beneath it. Over time, there is a potential for the post, the wheel, and even the foot to sink into the ground, making it difficult to later reattach the trailer to the towing vehicle.

Some trailer operators carry some type of jack post, wheel, or foot stabilizing accessory in the towing vehicle. Such stabilizing accessories currently include, for example, one or more blocks of wood, stackable pads, cinder blocks, a jack post sheath, boot, or feet. Still other examples include wheel platforms or docking stations that can be stacked or positioned beneath the jack post or the jack wheel. Many of these existing stabilizing accessories must be transported in the towing vehicle, rendering the accessories less convenient and prone to loss or damage. Other solutions must be incorporated directly into the trailer jack itself. Moreover, such stabilizing accessories generally accommodate a single, specific trailer jack geometry and do not have the flexibility or adjustability to stabilize or support more than one type of jack post, jack wheel or plate jack stand.

In addition, conventional wheel or tire chocks exist as entirely separate components from the stabilizing devices discussed above. Tire chocks typically are transported in the towing vehicle along with the stabilizing accessory, which is inconvenient, consumes storage space, and also risks loss of or damage to the tire chocks. Although existing solutions are workable, improvements in support structures continue to be of interest.

### SUMMARY

Embodiments of a support structure are disclosed. For example, the support structure can have a base with a top and recesses. Inserts can be mounted in respective ones of the recesses. Each insert can have a protrusion that extends from the respective insert. The inserts can be reversible and invertible. In some versions, the inserts can include: a first configuration where the protrusions extend above the top of the base and are located in a first position; a second configuration wherein the protrusions extend above the top of the base and are located in a second position that differs from the first position; and a third configuration wherein the protrusions extend into the recesses below the top of the base such that the inserts are substantially flush with the top of the base.

### BRIEF DESCRIPTION OF THE DRAWINGS

Before one or more embodiments are described in detail, one skilled in the art will appreciate that they are not limited in its application to the details of construction, the arrangements of components, and the arrangement of steps set forth in the following detailed description or illustrated in the drawings and descriptions. Rather, they are capable of other embodiments and of being practiced or being carried out in various ways. Also, it is to be understood that the phrases and terms used are for the purpose of description and should not be regarded as limiting.

FIGS. 1 and 2 are perspective views of an embodiment of a support structure in two different configurations, respectively.

FIGS. 3-5 are side, top and end views, respectively, of the embodiment of FIG. 1.

FIG. 6 is a perspective view of the embodiment of FIGS. 1 and 2 in a third configuration.

FIG. 7 is an exploded, perspective view of an embodiment of the support structure.

FIGS. 8-10 are perspective views of another embodiment of a support structure in three different configurations, respectively, with FIG. 10 shown in an exploded view.

FIGS. 11-12 are perspective views of still another embodiment of a support structure in two different configurations, respectively.

FIG. 13-15 are perspective views of an embodiment of the support structures in a stacked relationship, and are shown in three different configurations, respectively.

FIGS. 16-17 are sectional side views of embodiments of a support structure, and a stack of support structures, respectively.

FIGS. 18-22 are perspective views of other embodiments of a support structure while supporting different types of objects, respectively.

FIGS. 23-27 are perspective views of still other embodiments of a support structure with clockable positions for the inserts, and are shown in various configurations, respectively.

### DETAILED DESCRIPTION

The following descriptions of various implementations of the present teachings have been presented for purposes of illustration and description. These descriptions are not exhaustive and do not limit the present teachings to the precise form disclosed. Modifications and variations are possible in light of these teachings or may be acquired from practicing these teachings.

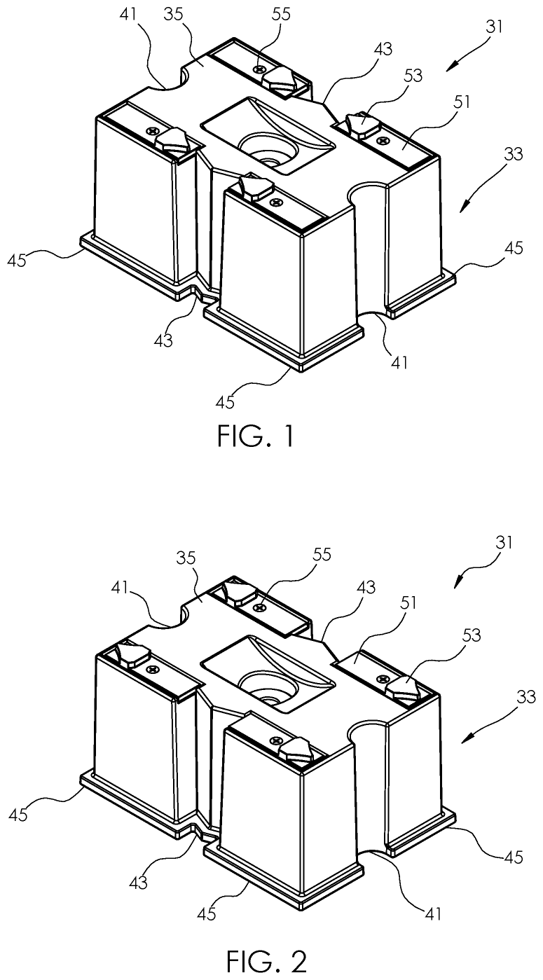

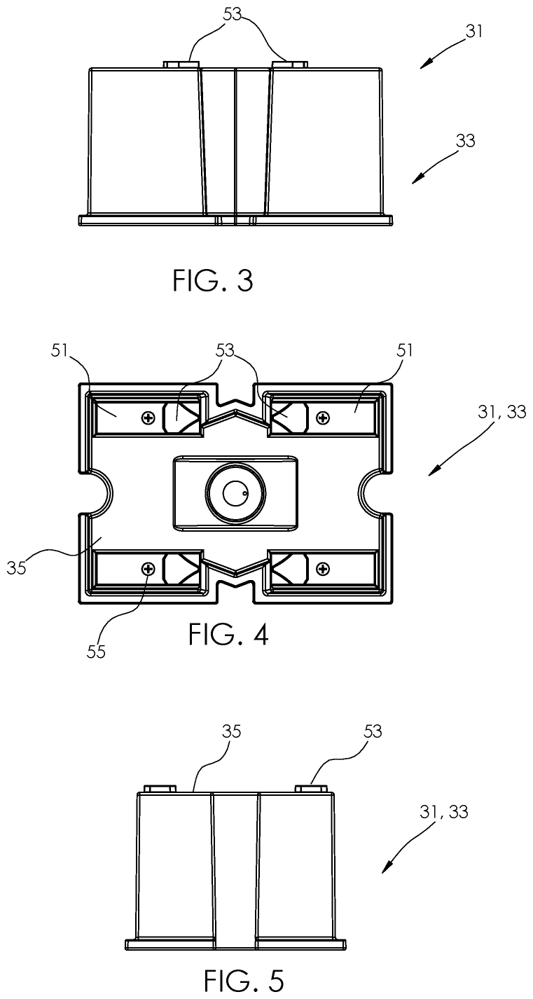

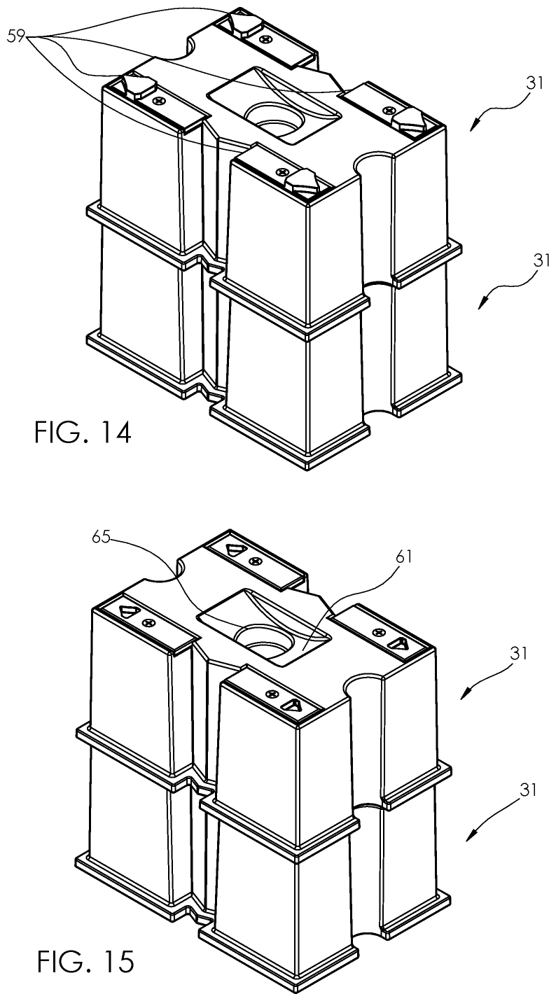

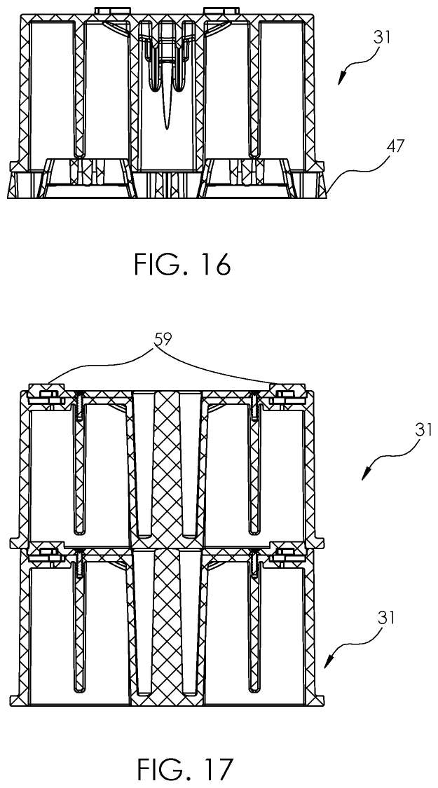

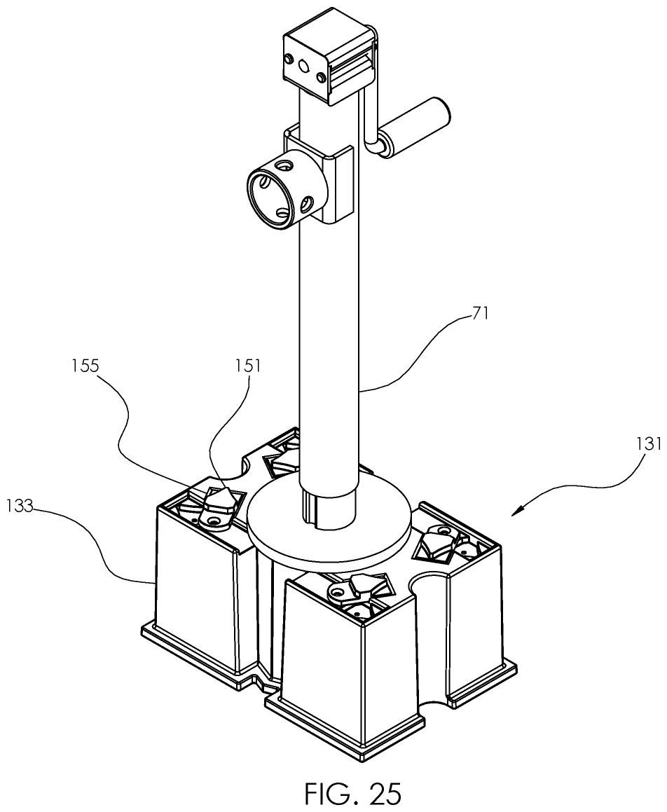

Referring to FIGS. 1-27, embodiments of a support structure are shown. For example, the drawings show a support structure 31 can include a base 33 having a top 35 with recesses 37 (e.g., FIG. 7). The base 33 can further comprise vertical reinforcement structures. For example, the vertical reinforcement structures can comprise concave features 41 (FIGS. 1-2) and convex features 43 that are integral and monolithic with the base 33.

In addition, the base 33 can include feet 45 that are longer and wider than the base 33. In one example (FIGS. 1 and 2), the base 33 can have feet 45 that match contours of the base 33. In another example, the base 33 can have a single foot 45 at and/or around a perimeter at a bottom of the base 33.

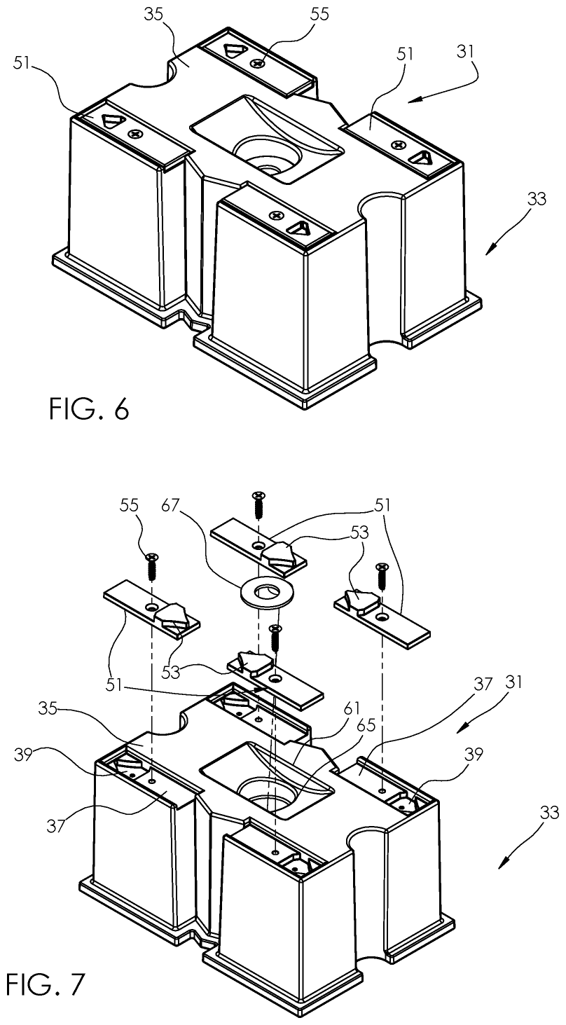

Embodiments of the support structure 31 can include inserts 51. The inserts 51 can be detachably mounted (compare FIGS. 1 and 7) in respective ones of the recesses 37. Each insert 51 can have a protrusion 53 that extends from the insert 51. Versions of the inserts 51 can be reversible (e.g., oriented in different directions; compare FIGS. 1 and 2)) and/or invertible (e.g., positioned up or down; compare FIGS. 2 and 6). For example, the inserts 51 can include a first configuration (FIGS. 1, 3-5 and 7). In the first configuration, the protrusions 53 can extend above the top 35 of the base 33 and are located in a first position. In the first position, the protrusions 53 can be located in close proximity to each other, as shown.

Versions of the support structure 31 can include a second configuration (FIG. 2). In the second configuration, the protrusions 53 can extend above the top 35 of the base 33 and can be located in a second position that differs from the first position. In the second position, for example, the protrusions 53 can be located further apart from each other than they are in the first configuration.

Embodiments of the support structure 31 can include a third configuration (FIG. 6). In the third configuration, the protrusions 53 can extend into the recesses 37 (FIG. 7) below the top 35 of the base 33 such that the inserts 51 are substantially flush with the top 35 of the base 33. The recesses 37 in the base 33 can comprise apertures 39 (FIG. 7), at least some of which can be complimentary in shape to the protrusions 53, so that the protrusions 53 can seat in the apertures 39 in the third configuration. Each insert 51 can be secured to a respective recess 27 in the base 33 with a fastener 55 in any of the configurations, in some versions.

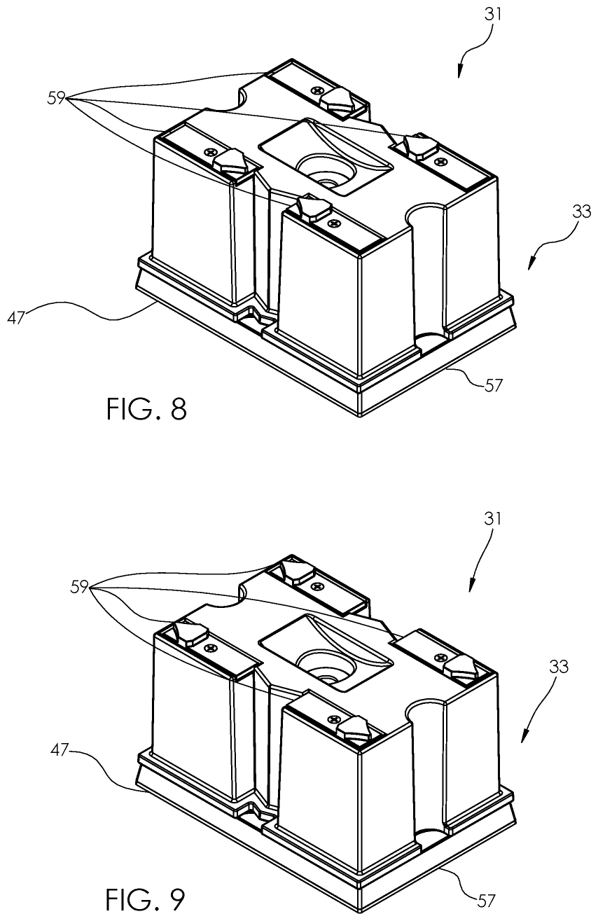

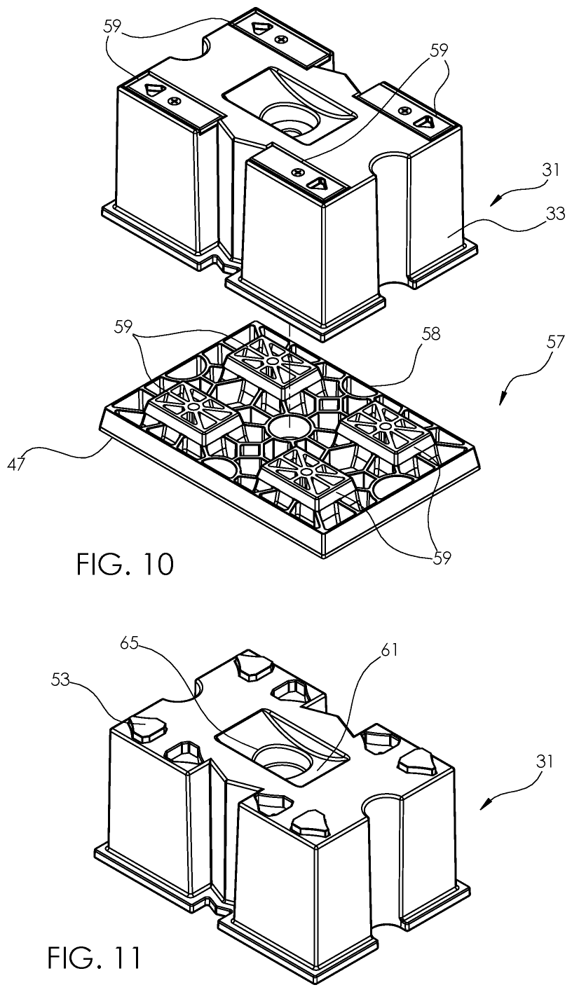

Other versions of the support structure 31 can further comprising one or more leveling pads 57 (FIGS. 8-10). Each leveling pad 57 can comprise a frame 58 (FIG. 10) that can be flat or relatively flat, and anchors 59 that extend upward from the frame 58. The leveling pads 57 can be stackable in a nesting configuration with each other. In addition, a bottom of the base 33 of the support structure 31 can seat on and receive one or more of the anchors 59 of the leveling pads 57, such as adjacent to each of the four corners of the leveling pad 57.

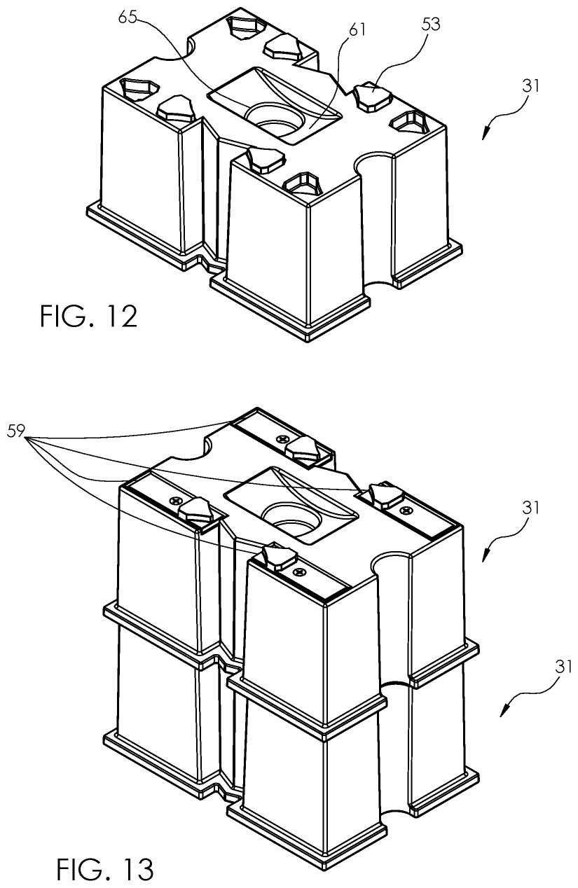

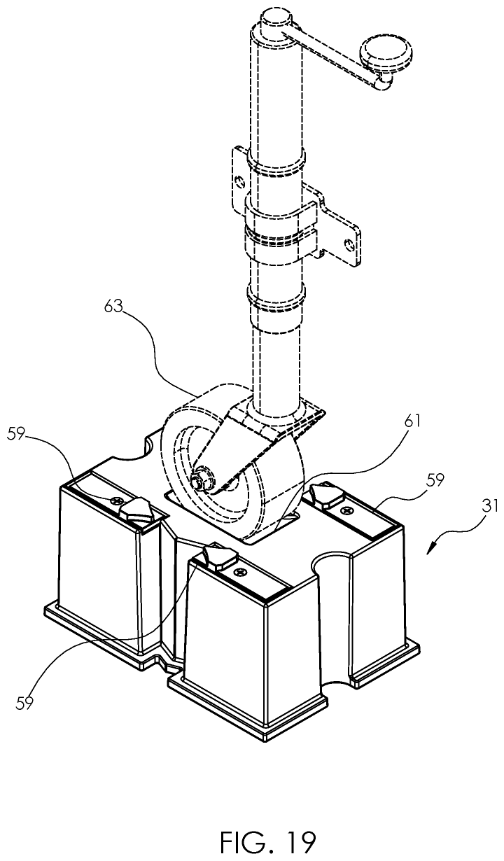

Referring now to FIGS. 11-12, another embodiment of a support structure 31 is shown. Versions of the support structure 31 can have the top 35 of the base 33 include a concave blind hole 61 that can be configured to receive an object, such as a wheel 63 (FIG. 19) of a trailer. In some examples, the concave blind hole 61 can include a cylindrical seat 65 (FIGS. 11-12) that extends below the concave blind hole 61. The cylindrical seat 65 can be configured to receive a cylindrical post (not shown). In addition, the cylindrical seat 65 can include a metal washer 67 (FIG. 7) located at the bottom of the cylindrical seat 65. Comparing the examples of FIGS. 11-12, the protrusions 53 can themselves be mounted in different apertures to render the support structure 31 in different configurations.

As shown in FIGS. 13-17, embodiments of the support system that includes the support structure 31 can further include a second support structure 31 (e.g., such as two or three or more) that is identical to the support structure 31. The support structures 31 can be stackable, such that a portion of the top of the support structure 31 nests in and extends into a bottom of the second support structure 31. Thus, the base 33 can include a bottom (see FIGS. 10, 16 and 17) that is open and shaped to nest and be secured on another object, such as another support structure 31. In FIG. 17, note how support structures 31 can receive anchors 59 to further enable secure stacking of the support structures 31.

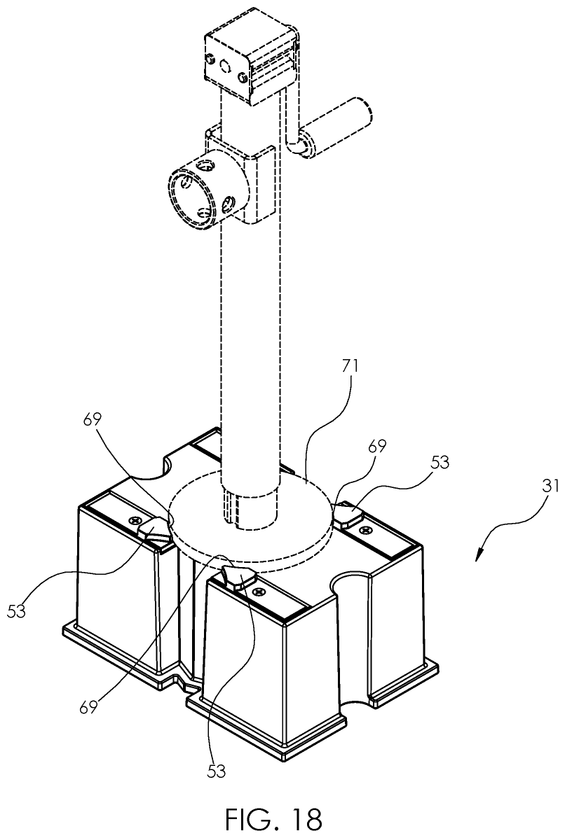

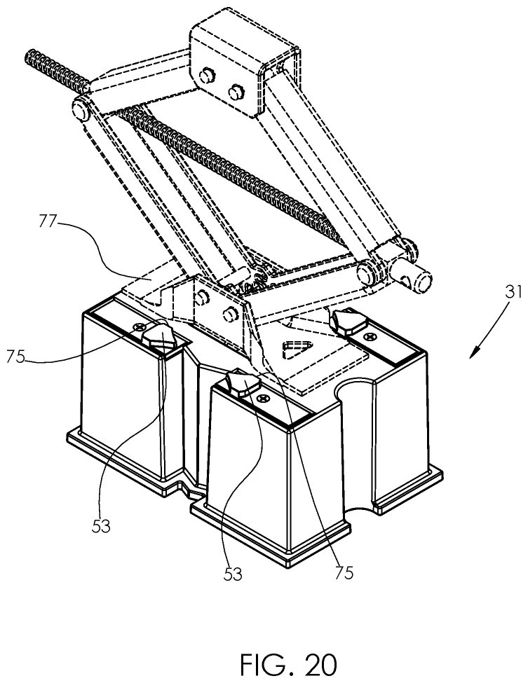

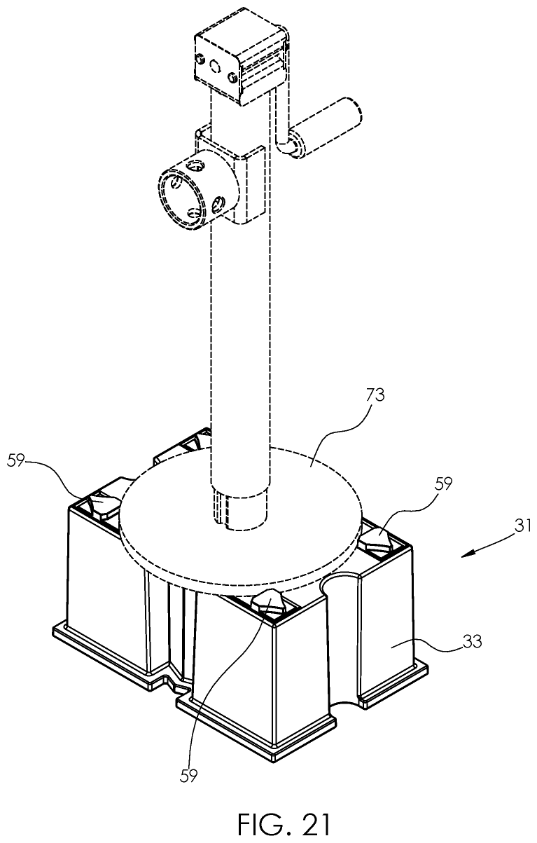

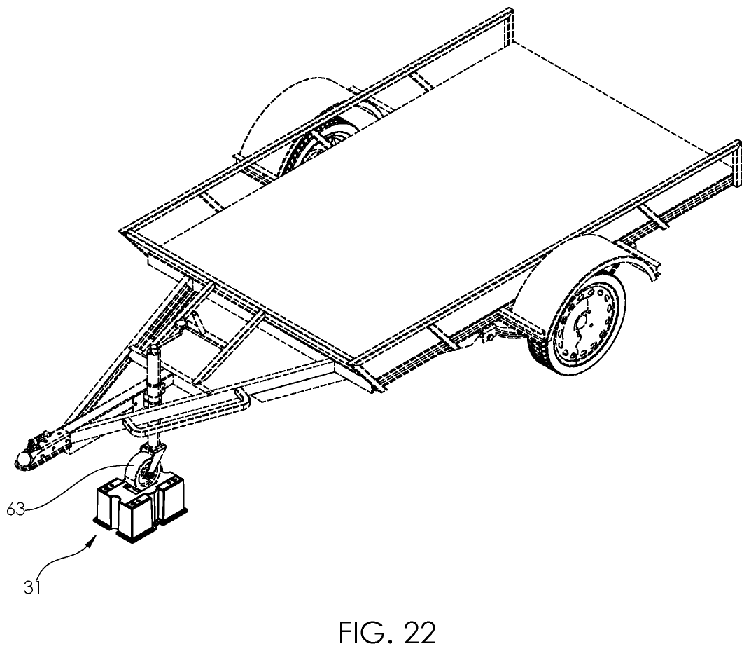

As shown in FIG. 18, embodiments of the support structure 31 can include the protrusions 53 having curved features 69. In the first configuration, the curved features 69 of the protrusions 53 can be configured to closely receive, for example, a round foot 71 of a trailer that is narrower than a width of the base 33. In the second configuration, the protrusions 53 can be configured to closely receive, for example, a round foot 73 (FIG. 21) of a trailer that is wider than the base 33. In addition, the protrusions 53 can be provided with linear or rectangular features 75 (FIG. 20) that are configured to closely receive, for example, a rectangular foot 77 of a scissor jack. In other embodiments, the support structure 31 can be configured to support, for example, a wheel 63 (FIGS. 19, 22), a fifth wheel, post, trailer jack, tow behind trailer, etc.

In some of the illustrated examples of FIGS. 18-21, each protrusion 53 can comprise a rear wall that is rectangular, side walls that are rectangular and front portions that are concave or curved and form a point at a front thereof.

Embodiments of the support structure 31 can be made from a variety of materials, such as one or more of HDPE, recycled HDPE, virgin HDPE, UV inhibitors and other polymers. In some versions, the support structure 31 can weigh about 3 pounds to about 12 pounds, such as about 5.6 pounds. The components can be compression molded and can be rated to support 2000 pounds or more, such as up to about 20,000 pounds.

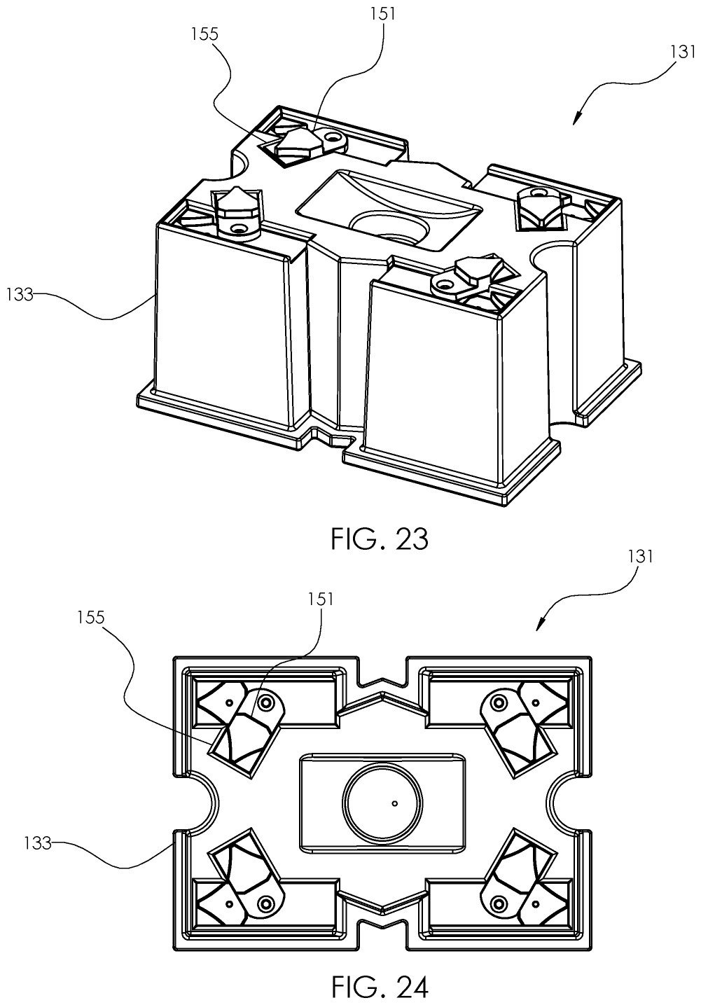

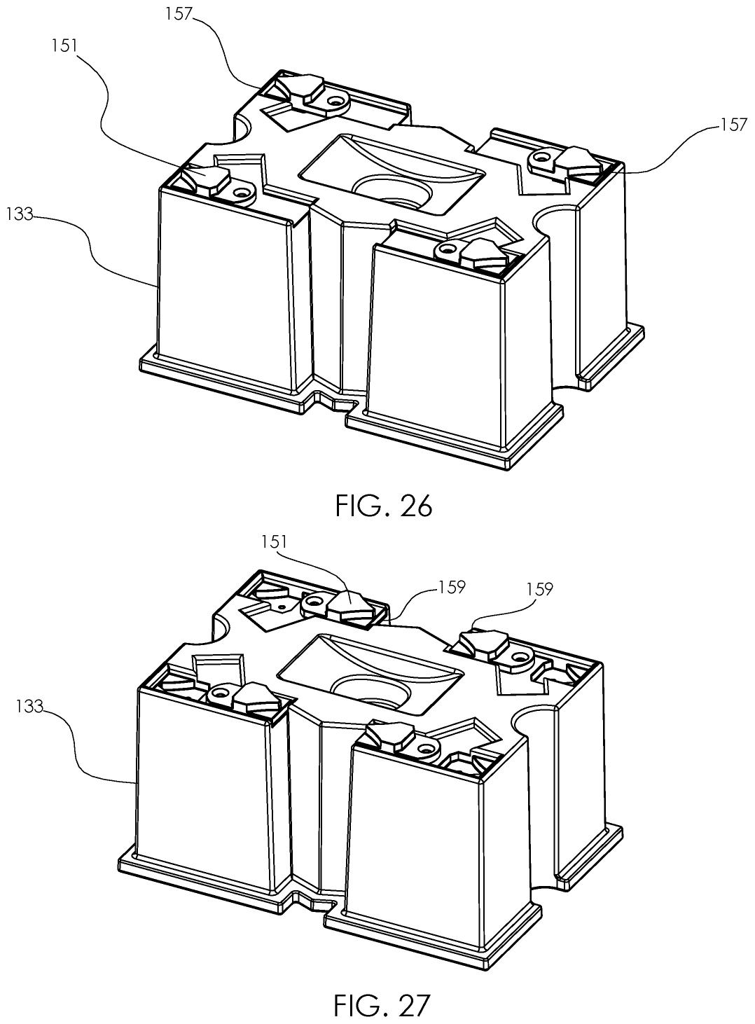

FIGS. 23-27 are various views of still other embodiments of a support structure 131 with a base 133 and clockable positions for the inserts 151. In FIGS. 23-25, the inserts 151 are shown mounted in clocked or canted (relative to the longitudinal and lateral axes of support structure 131) recesses 155. In FIG. 26, the inserts 151 are alternatively shown mounted in outer orthogonal recesses 157 (e.g., parallel to the longitudinal axis, perpendicular to the lateral axis). In FIG. 27, however, the inserts 151 are shown mounted in inner orthogonal recesses 159. In a first configuration, the inserts 151 are repositionable at two or more rotated clock positions at angular orientations with respect to the base 133. Each rotated clock position can comprise a specific recess, such as recesses 155, 157 or 159.

Still other embodiments can include one or more of the following items.
1. A support block for supporting a weight of an object that can be towed by a motor vehicle, comprising:
   a base having a top with recesses;
   protrusions mounted in respective ones of the recesses, and each protrusion comprises:
      a first configuration wherein the protrusions are coupled to the base and extend above the top of the base and are configured to surround a portion of a support for the object; and
      a second configuration wherein the protrusions oriented relative to the base in a different way than the first configuration.
2. The support block wherein the protrusions are repositionable at two or more rotated clock positions at angular orientations with respect to the base.
3. The support block wherein each rotated clock position comprises different specific recesses for the protrusions, respectively.
4. The support block wherein the base is configured to support a jack with the weight of the object on the jack.
5. The support block wherein, in the second configuration, the protrusions are removed from the base.
6. The support block wherein, in the second configuration, the protrusions extend into the recesses of the base such that the protrusions are flush with the top of the base.
7. A support structure, comprising:
   a base having a top with recesses;
   inserts mounted in respective ones of the recesses, each insert having a protrusion that extends therefrom, the inserts are reversible and invertible, and the inserts comprise:
      a first configuration wherein the protrusions extend above the top of the base and are located in a first position;
      a second configuration wherein the protrusions extend above the top of the base and are located in a second position that differs from the first position; and
      a third configuration wherein the protrusions extend into the recesses below the top of the base such that the inserts are substantially flush with the top of the base.
8. The support structure of claim 7, wherein the recesses in the base comprise apertures that are complimentary in shape to the protrusions so that the protrusions seat in the apertures in the third configuration.
9. The support structure wherein each insert is secured to a respective recess in the base with a fastener.
10. The support structure further comprising a second support structure that is identical to the support structure and stackable on the support structure such that a portion of the top of the support structure nests and extends into a bottom of the second support structure.
11. The support structure wherein the base further comprises vertical reinforcement structures.
12. The support structure wherein the vertical reinforcement structures comprise concave and convex features that are integrally and monolithically formed with the base.
13. The support structure wherein the base comprises feet that are longer and wider than the base.
14. The support structure wherein the base comprises feet that match contours of the base.
15. The support structure wherein the base comprises a single foot around a bottom of the base.
16. The support structure wherein the base comprises a bottom that is open to nest on another object.
17. The support structure wherein the top of the base comprises a concave blind hole configured to receive and support a wheel of an object.
18. The support structure wherein the concave blind hole comprises a cylindrical seat that extends below the concave blind hole, and the cylindrical seat is configured to receive a cylindrical post.
19. The support structure further comprising a metal washer located at a bottom of the cylindrical seat.
20. The support structure wherein the protrusions have curved features and, in the first configuration, the curved features of the protrusions are configured to closely receive a foot of an object that is narrower than a width of the base.
21. The support structure wherein, in the second configuration, the protrusions are configured to closely receive a foot of an object that is wider than the base.
22. The support structure wherein the protrusions have linear features that are configured to closely receive a rectangular foot of a scissor jack.
23. The support structure wherein the support structure is configured to support a fifth wheel, post, trailer jack or tow behind trailer.
24. The support structure further comprising a leveling pad having a flat base and anchors that extend upward from the flat base, the leveling pad is stackable in a nesting configuration with another leveling pad, and a bottom of the base is seated on the leveling pad and receives the anchors of the leveling pad.
25. The support structure wherein each protrusion comprises a rear wall that is linear, side walls that are linear and front portions that are concave and form a point at a front thereof.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” is employed to describe elements and components described herein. This is done merely for convenience and to give a general sense of the scope of the invention. This description should be read to include one or at least one and the singular also includes the plural unless it states otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

What is claimed is:

1. A support block for supporting a weight of an object that can be towed by a motor vehicle, comprising:
a base having a top with recesses;
protrusions mounted in respective ones of the recesses, and each protrusion comprises:
a first configuration wherein the protrusions are coupled to the base and extend above the top of the base and are configured to surround a portion of a support for the object; and
a second configuration wherein the protrusions oriented relative to the base in a different way than the first configuration.

2. The support block of claim 1 wherein the protrusions are repositionable at two or more rotated clock positions at angular orientations with respect to the base.

3. The support block of claim 2, wherein each rotated clock position comprises different specific recesses for the protrusions, respectively.

4. The support block of claim 1, wherein the base is configured to support a jack with the weight of the object on the jack.

5. The support block of claim 1 wherein, in the second configuration, the protrusions are removed from the base.

6. The support block of claim 1 wherein, in the second configuration, the protrusions extend into the recesses of the base such that the protrusions are flush with the top of the base.

7. A support structure, comprising:
a base having a top with recesses;
inserts mounted in respective ones of the recesses, each insert having a protrusion that extends therefrom, the inserts are reversible and invertible, and the inserts comprise:
a first configuration wherein the protrusions extend above the top of the base and are located in a first position;
a second configuration wherein the protrusions extend above the top of the base and are located in a second position that differs from the first position; and
a third configuration wherein the protrusions extend into the recesses below the top of the base such that the inserts are substantially flush with the top of the base.

8. The support structure of claim 7, wherein the recesses in the base comprise apertures that are complimentary in shape to the protrusions so that the protrusions seat in the apertures in the third configuration.

9. The support structure of claim 7, wherein each insert is secured to a respective recess in the base with a fastener.

10. The support structure of claim 7, further comprising a second support structure that is identical to the support structure and stackable on the support structure such that a portion of the top of the support structure nests and extends into a bottom of the second support structure.

11. The support structure of claim 7, wherein the base further comprises vertical reinforcement structures.

12. The support structure of claim 11, wherein the vertical reinforcement structures comprise concave and convex features that are integrally and monolithically formed with the base.

13. The support structure of claim 7, wherein the base comprises feet that are longer and wider than the base.

14. The support structure of claim 7, wherein the base comprises feet that match contours of the base.

15. The support structure of claim 7, wherein the base comprises a single foot around a bottom of the base.

16. The support structure of claim 7, wherein the base comprises a bottom that is open to nest on another object.

17. The support structure of claim 7, wherein the top of the base comprises a concave blind hole configured to receive and support a wheel of an object.

18. The support structure of claim 17, wherein the concave blind hole comprises a cylindrical seat that extends below the concave blind hole, and the cylindrical seat is configured to receive a cylindrical post.

19. The support structure of claim 18, further comprising a metal washer located at a bottom of the cylindrical seat.

20. The support structure of claim 7, wherein the protrusions have curved features and, in the first configuration, the curved features of the protrusions are configured to closely receive a foot of an object that is narrower than a width of the base.

21. The support structure of claim 7, wherein, in the second configuration, the protrusions are configured to closely receive a foot of an object that is wider than the base.

22. The support structure of claim 7, wherein the protrusions have linear features that are configured to closely receive a rectangular foot of a scissor jack.

23. The support structure of claim 7, wherein the support structure is configured to support a fifth wheel, post, trailer jack or tow behind trailer.

24. The support structure of claim 7, further comprising a leveling pad having a flat base and anchors that extend upward from the flat base, the leveling pad is stackable in a nesting configuration with another leveling pad, and a bottom of the base is seated on the leveling pad and receives the anchors of the leveling pad.

25. The support structure of claim 7, wherein each protrusion comprises a rear wall that is linear, side walls that are linear and front portions that are concave and form a point at a front thereof.
